(19) United States
(12) Patent Application Publication
(10) Pub. No.: US 2026/0336663 A1
(43) Pub. Date: Oct. 29, 2026

(54) AUTONOMOUS VEHICLE CONTROL DEVICE AND METHOD

(71) Applicants: Hyundai Motor Company, Seoul (KR); Kia Corporation, Seoul (KR)

(72) Inventors: Jeong Soo KIM, Hwaseong-Si (KR); Ju Eun LEE, Hwaseong-Si (KR); Se Won JANG, Hwaseong-Si (KR)

(21) Appl. No.: 19/400,140

(22) Filed: Nov. 25, 2025

(30) Foreign Application Priority Data
Apr. 23, 2025 (KR) 10-2025-0053048

(51) Int. Cl. B60W 60/00; B60W 30/18

(52) U.S. Cl. CPC B60W 60/0015; B60W 30/18163; B60W 2552/10; B60W 2554/20; B60W 2554/4041; B60W 2554/4042

(57) ABSTRACT

[symbol]

paratus of a vehicle may comprise one or more sensors configured to obtain object ition information associated with at least one external object in a surrounding nment of the vehicle and driving information of the vehicle, one or more processors coupled to the one or more sensors, and a memory storing instructions that, when executed by the one or more processors, are configured to cause the apparatus to detect the at least one external object, determine a class of the at least one detected external object, identify a plurality of construction structure candidates, determine a construction structure by clustering the plurality of construction structure candidates, generate a virtual construction zone and an avoidance zone, determine a response action, output a signal indicating a driving route, and control autonomous driving.

### CROSS-REFERENCE TO RELATED APPLICATION

This application claims the benefit of priority to Korean Patent Application No. 10-2025-0053048, filed in the Korean Intellectual Property Office on Apr. 23, 2025, the disclosure of which is incorporated herein by reference in its entirety.

### TECHNICAL FIELD

Examples relate to an autonomous vehicle control device and method.

### BACKGROUND

The matters described in this Background section are only for enhancement of understanding of the background of the disclosure, and should not be taken as acknowledgment that they correspond to prior art already known to those skilled in the art.

Autonomous vehicle technology may be capable of responding to various situations in road environments. For example, vehicles targeting Level 4 autonomous driving may be able to handle most driving situations on their own without driver intervention, which means that technology for accurately recognizing and avoiding obstacles on the road, especially non-drivable regions such as construction structures, is essential.

In autonomous driving technology, a method of utilizing sensors such as a camera, a lidar, and a radar to recognize external objects and planning a route based on the recognition may be used. However, in complex environments such as construction zones, accurate determination may be challenging since the shapes and positions of construction structures vary and the states of some objects may be classified as unknown.

### SUMMARY

Various examples of the disclosure including an autonomous vehicle control device and method capable of allowing an autonomous vehicle to stably recognize and avoid a construction zone in various road environments.

The present disclosure is also directed to providing an autonomous vehicle control device and method capable of significantly improving the safety and reliability of autonomous driving.

According to the present disclosure, an apparatus of a vehicle may comprise one or more sensors configured to obtain object recognition information associated with at least one external object in a surrounding environment of the vehicle and driving information of the vehicle, one or more processors coupled to the one or more sensors, and a memory storing instructions that, when executed by the one or more processors, are configured to cause the apparatus to detect, based on the object recognition information, the at least one external object, determine a class of the at least one detected external object, and based on the determined class and location information of the at least one detected external object, identify a plurality of construction structure candidates.

The instructions may further cause the apparatus to determine a construction structure by clustering the plurality of construction structure candidates, generate, based on the construction structure, a virtual construction zone and an avoidance zone, determine, based on the avoidance zone, a response action of the vehicle, output, based on the response action, a signal indicating a driving route of the vehicle, and control, based on the signal, autonomous driving of the vehicle.

The instructions, when executed by the one or more processors, may be configured to cause the apparatus to determine the at least one detected external object as a reference object, based on the at least one detected external object being classified as the construction structure. The instructions, when executed by the one or more processors, may be configured to cause the apparatus to determine the at least one detected external object as a reference object, based on the at least one detected external object being classified as the construction structure at a previous point in time.

The instructions, when executed by the one or more processors, may be configured to cause the apparatus to, based on the at least one detected external object being classified as a stationary object and occupying a road, determine that the at least one detected external object is one of the plurality of construction structure candidates.

The instructions, when executed by the one or more processors, may be configured to cause the apparatus to, based on information associated with at least one of a size of the at least one detected external object, a speed of the at least one detected external object, or road occupancy of the at least one detected external object, determine that the at least one detected external object is one of the plurality of construction structure candidates, and wherein the at least one detected external object is classified as an unclassified object.

The instructions, when executed by the one or more processors, may be configured to cause the apparatus to determine that the unclassified object is one of the plurality of construction structure candidates based on a size of the unclassified object being less than or equal to a reference size, a speed of the unclassified object being less than or equal to a reference speed, and the unclassified object occupying a road.

The instructions, when executed by the one or more processors, may be configured to cause the apparatus to determine a similarity between a construction structure candidate and a reference object, wherein an object among the at least one detected external object is classified as the reference object, and wherein the construction structure candidate is one of the plurality of construction structure candidates.

The instructions, when executed by the one or more processors, may be configured to cause the apparatus to, based on the similarity being less than or equal to a preset threshold value, cluster the construction structure candidate with the reference object and determine that the construction structure candidate clustered with the reference object is a construction structure.

The instructions, when executed by the one or more processors, may be configured to cause the apparatus to, based on setting the construction structure as a reference point, generate the virtual construction zone covering the construction structure and generate the avoidance zone by adding a buffer zone to the virtual construction zone.

The instructions, when executed by the one or more processors, may be configured to cause the apparatus to determine the response action of the vehicle further based on the driving information.

According to the present disclosure, a method performed by an apparatus of a vehicle may comprise obtaining, from a sensor, object recognition information associated with at least one external object in a surrounding environment of the vehicle and driving information of the vehicle, detecting, based on the object recognition information, the at least one external object, and determining a class of the at least one detected external object.

The method may further comprise, based on the determined class and location information of the at least one external object, determining a plurality of construction structure candidates, determining a construction structure by clustering the plurality of construction structure candidates, generating, based on the construction structure, a virtual construction zone and an avoidance zone, determining, based on the avoidance zone, a response action of the vehicle, outputting, based on the response action, a signal indicating a driving route of the vehicle, and controlling, based on the signal, autonomous driving of the vehicle.

According to the present disclosure, a vehicle may comprise a sensor configured to obtain object information of at least one external object in a surrounding environment of the vehicle, a driving control circuit configured to control autonomous driving of the vehicle, and a processor circuit configured to cause the vehicle to determine, based on the object information, a class of the at least one external object.

The processor circuit may further cause the vehicle to identify, based on the class and the object information, a plurality of candidate structures, determine, based on clustering the plurality of candidate structures, at least one construction structure, identify, based on the at least one construction structure, an avoidance zone, select, based on the avoidance zone, a driving operation of the vehicle, output, based on the driving operation, a signal indicating a driving route of the vehicle, and control, via the driving control circuit and based on the signal, autonomous driving of the vehicle.

The processor circuit may be configured to cause the vehicle to determine a level of similarity between a candidate structure and a reference object, based on location information of the at least one external object and lane link information associated with the driving route of the vehicle, and wherein the candidate structure is one of the plurality of candidate structures.

The processor circuit may be configured to cause the vehicle to determine the driving operation as at least one of biased driving within a lane, lane encroaching bias, or a lane change. The processor circuit may be configured to cause the vehicle to identify the avoidance zone by adding a buffer zone to a construction zone, wherein the buffer zone is set based on a speed limit associated with the driving route of the vehicle, and wherein the construction zone is defined based on the construction structure.

### BRIEF DESCRIPTION OF THE DRAWINGS

The above and other objects, features and advantages of the present disclosure will become more apparent to those of ordinary skill in the art by describing various examples thereof in detail with reference to the accompanying drawings, in which:

FIG. 1 shows an example of a vehicle transmitting and receiving data by communicating with other devices;

FIG. 2 shows an example of modules constituting a vehicle;

FIG. 3 shows an exemplary operation of an autonomous vehicle control device;

FIG. 4, FIG. 5, FIG. 6, and FIG. 7 show exemplary operations of a processor; and

FIG. 8 shows an example of a method of controlling an autonomous vehicle.

FIG. 9 shows an example computing system.

### DETAILED DESCRIPTION

Hereinafter, preferred examples of the present disclosure will be described in detail with reference to the accompanying drawings.

However, the technical idea of the present disclosure is not limited to some examples to be described but may be implemented in various different forms, and within the scope of the technical idea of the present disclosure, one or more among components in the examples may be used by being selectively combined and substituted.

Further, unless specifically defined and described, terms used in the examples of the present disclosure (including technical and scientific terms) may be interpreted with meanings which are generally understood by those skilled in the art to which the present disclosure pertains, and commonly used terms such as terms defined in dictionaries may be interpreted in consideration of the contextual meaning of the related art.

The terms used in the examples of the present disclosure are for the purpose of describing the examples only and are not intended to limit the disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. In addition, when describing components of examples of the present disclosure, terms such as “first,” “second,” “A,” “B,” “(a),” “(b),” etc., may be used.

These terms are only for distinguishing the components from other components, and the essence, sequence, or order of the components is not limited by these terms.

In addition, when a component is described as being “linked,” “coupled,” or “connected” to another component, the component may not only be directly linked, coupled, or connected to the other component, but may also be “linked,” “coupled,” or “connected” to the other component with still another component disposed between the component and the other component.

Further, when a component is described as being formed or disposed “on (above) or under (below)” another component, the term “on (above) or under (below)” includes not only when the two components are in direct contact with each other, but also when one or more other components are formed or disposed between the two components. Further, when a component is described as being “on (above) or below (under),” the description may include the meanings of an upward direction and a downward direction based on one component.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of clustering-based construction zone recognition) described herein, an operation of the vehicle may be controlled. For example, when construction structures (e.g., cones, barriers, temporary signs, or roadside equipment, etc.) are clustered to recognize a construction zone, the autonomous driving control may adjust driving features such as sensor fusion control, braking control, braking time control, acceleration control, acceleration change rate control, alarm timing control, and forward collision warning time control. The vehicle control may thereby ensure safe passage near the clustered construction zone by dynamically modifying path planning, applying biased driving, or initiating lane changes based on the avoidance zone derived from the clustered recognition.

One or more auxiliary devices (e.g., engine brake, exhaust brake, hydraulic retarder, electric retarder, regenerative brake, etc.) may also be controlled, for example, based on one or more features (e.g., feature of clustering-based construction zone recognition) described herein. In particular, when clustered construction structures (e.g., cones, barriers, temporary road equipment, or construction vehicles, etc.) are detected and a construction zone is recognized, the auxiliary devices may be adjusted to enhance vehicle stability and safety. For example, the regenerative brake may be activated to smoothly decelerate the vehicle when approaching a clustered construction zone, the engine brake may be applied to control speed on downhill segments near construction areas, or the exhaust brake may be used to provide additional braking torque when lane encroachment or avoidance maneuvers are required. Such control allows the vehicle to maintain safe operation within or around the clustered construction zone while reducing wear on the primary braking system.

One or more communication devices (e.g., a modem, a network adapter, a radio transceiver, an antenna, etc.), that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc., may also be controlled, for example, based on one or more features (e.g., feature of clustering-based construction zone recognition) described herein. In particular, when clustered construction structures (e.g., cones, barriers, temporary road signs, or construction vehicles, etc.) are detected and a construction zone is recognized, the communication device may transmit construction zone information to nearby vehicles via V2X, send updates to an infrastructure server for traffic management, or receive cooperative maneuvering instructions from a road-side unit. The system may also prioritize certain communication channels (e.g., LTE or 5G for low-latency warnings, Wi-Fi for map updates, or Bluetooth/NFC for in-vehicle device synchronization, etc.) to ensure reliable dissemination of construction zone data.

Minimum risk maneuver (MRM) operation(s) may also be controlled, for example, based on one or more features (e.g., feature of clustering-based construction zone recognition) described herein. A minimal risk maneuvering operation (e.g., a minimal risk maneuver, a minimum risk maneuver) may be a maneuvering operation of a vehicle to minimize a risk of collision with surrounding vehicles or roadside structures in order to reach a lowered risk state. In particular, when construction structures are detected and clustered (e.g., cones, barriers, temporary signs, or construction vehicles, etc.) to form a construction zone, the MRM may be activated to guide the vehicle into a safe stop position or controlled driving state that avoids the clustered construction zone. For example, the MRM may bias the vehicle laterally within a lane, initiate a controlled lane change, or decelerate to a stop in a clear area of the roadway outside the clustered construction zone. A minimal risk maneuver may be an operation that is activated during autonomous driving of the vehicle when a driver is unable to respond to a request to intervene. During the minimal risk maneuver, one or more processors of the vehicle may control a driving operation of the vehicle for a set period of time, considering the avoidance zone derived from the clustered construction zone to ensure stability and safety.

Biased driving operation(s) may also be controlled, for example, based on one or more features (e.g., feature of clustering-based construction zone recognition) described herein. A driving control apparatus may perform a biased driving control when clustered construction structures (e.g., cones, barriers, or temporary roadside objects, etc.) are recognized as forming a construction zone. To perform biased driving, the driving control apparatus may control the vehicle to drive in a lane while maintaining a lateral distance that avoids the avoidance zone generated from the clustered construction zone. For example, the driving control apparatus may control the vehicle to stay in the lane but intentionally shift laterally to keep a safe clearance from the clustered construction zone rather than remain centered in the lane. The driving control apparatus may identify or determine a biased target lateral distance for biased driving control based on the position, size, and lane occupancy of the clustered construction structures. For example, a biased target lateral distance may comprise an adjusted offset that allows the vehicle to maintain a safe gap from the clustered construction structures while remaining within the lane boundaries. This adjustment may be made to improve the vehicle's stability, safety, and/or performance under varying road conditions. For example, when clustered construction structures encroach into the host lane, the driving control system may bias the lateral distance to shift the vehicle slightly away from the avoidance zone, considering factors such as the vehicle's speed, lane width, and the presence of adjacent vehicles.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of clustering-based construction zone recognition) described herein. In particular, when a construction zone is recognized by clustering multiple construction structure candidates (e.g., cones, barriers, temporary signs, or construction vehicles, etc.), the vehicle may selectively control its sensors by increasing the sampling rate of the LIDAR, activating additional cameras for side views, prioritizing RADAR for moving-object detection, or fusing map-based lane-link data with sensor data, etc. An operation control for autonomous driving of the vehicle may therefore adjust sensing modes and coverage to enhance recognition of the clustered construction zone, and coordinate various driving control of the vehicle by the vehicle control device (e.g., acceleration, deceleration, steering control, braking system control, lane keeping assist control, collision avoidance system control, or adaptive headlight control, etc.).

An autonomous driving level and/or autonomous driving activation/deactivation may also be controlled, for example, based on one or more features (e.g., feature of clustering-based construction zone recognition) described herein. A driving control apparatus may perform an autonomous driving level control (e.g., a change of an autonomous driving level, a change of a required user attentiveness, etc.) or cause deactivation of an autonomous driving operation. For example, by detecting and clustering construction structure candidates (e.g., cones, barriers, temporary signs, or roadside equipment, etc.), the processor may recognize a construction zone and determine whether to maintain, change, or deactivate an autonomous driving level. In such a case, the driver may be required to take over control more often in complex environments (e.g., narrowed lanes, partial lane blockages, or full lane closures, etc.). By changing the autonomous driving level in response to clustered construction zone recognition, the system may also limit or restrict certain functions (e.g., video playback, navigation overlay, or entertainment features, etc.) on a display of the vehicle to increase driver attentiveness.

Hereinafter, examples will be described in detail with reference to the accompanying drawings, but the same or corresponding components are denoted by the same reference numerals throughout the drawings, and redundant descriptions thereof will be omitted.

According to the present disclosure, an autonomous vehicle control device and method may enable a vehicle to stably recognize and avoid road construction zones in diverse driving environments. The device may utilize sensors such as cameras, radar, and lidar to obtain object recognition information and vehicle driving information, and a processor may classify external objects, identify construction structure candidates, and cluster the candidates to determine construction structures. Based on the determined construction structures, the processor may generate a virtual construction zone and an avoidance zone with safety buffers, and then determine an appropriate response action including biased driving, partial lane encroachment, or a full lane change. A driving route reflecting the response action may be generated and displayed, thereby improving safety and reliability of autonomous driving by allowing the vehicle to adapt in real time to construction-related obstacles.

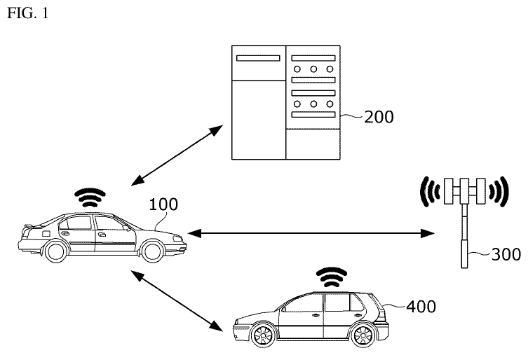

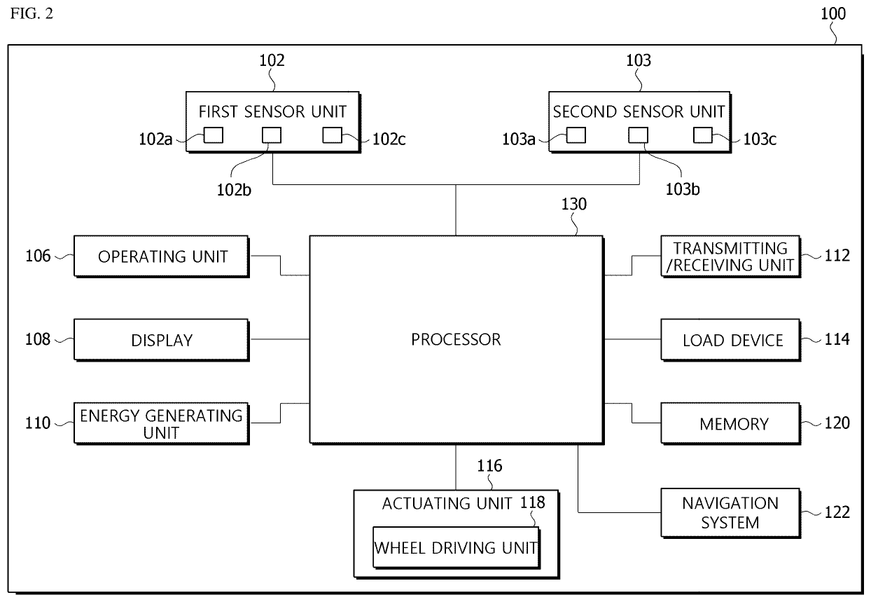

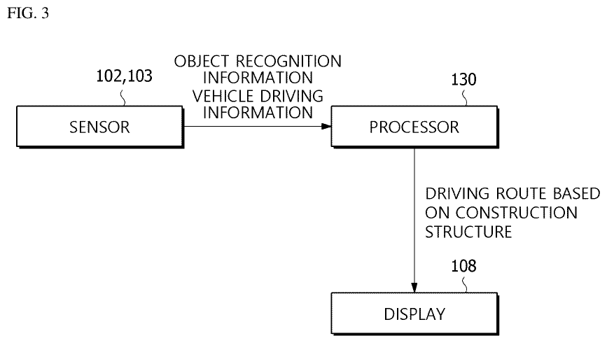

Hereinafter, a vehicle will be described with reference to FIGS. 1 and 2. FIG. 1 is a view illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas, for example, in a liquefied state. Here, one example of the gas may be hydrogen. However, the gas is not limited thereto, and various gases are applicable (e.g., methane, ammonia, natural gas, or biogas, etc.). In the case of a vehicle driven based on fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle (e.g., parallel hybrid, series hybrid, plug-in hybrid, or mild hybrid, etc.).

The vehicle 100 may refer to a movable device. The vehicle 100 is a ground vehicle that travels on the ground and may be a typical passenger car, a commercial vehicle, a purpose-built vehicle (PBV), or the like (e.g., taxi, delivery van, or ride-sharing shuttle, etc.). The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, dump truck, fire truck, crane, or excavator, etc. Here, the ground vehicle may be any vehicle including a vehicle that moves underground as well as a vehicle that moves over land. The vehicle 100 may be a robot in a broad sense, such as a means of movement, and the robot may move using wheels, tracks, or other movement modules. In the present disclosure, ground mobility devices such as ground vehicles are mainly described, but unless it contradicts the present disclosure, the present example may also be applied to air mobility devices such as an advanced air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention (e.g., lane keeping, automatic overtaking, highway merging, or parking without assistance, etc.), even if a driving situation is uncertain. Semi-autonomous driving may be provided as autonomous movement that requires driver intervention in some specific driving situations (e.g., construction zones, poor weather, unusual traffic signals, or emergency vehicle approach, etc.). The semi-autonomous driving may be implemented so that the processor 130 transfers control to a user by deactivating autonomous driving when such a situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, or various types of user devices (e.g., smartphones, wearable devices, or tablets, etc.). The server 200 may be, for example, an external device operated by a vehicle manufacturer or provided to service autonomous driving, and may receive connected data of the vehicle 100 or transmit data necessary for autonomous driving. The server 200 may transmit various pieces of information and software modules (e.g., navigation updates, hazard alerts, AI-based driving strategies, or infotainment services, etc.) used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100 (e.g., signal phase and timing data, toll information, road hazard broadcasts, or congestion updates, etc.). The vehicle 100 may support manual driving or autonomous driving (e.g., cooperative adaptive cruise control, collision warning, or platooning, etc.) by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC, Bluetooth, Wi-Fi Direct, or satellite communication, etc. used in the vehicle 100 may be used for communication between vehicles. The communication method between the vehicle 100, the server 200, the ITS device 300, the other vehicle 400, and the user device is not limited to the above-described example.

FIG. 2 shows an example of modules constituting a vehicle according to one example of the present disclosure;

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, a user operation, and a boarding space of the vehicle 100 (e.g., monitoring tire pressure, detecting rain on the windshield, identifying pedestrian movements, or sensing driver fatigue, etc.).

Specifically, the first sensor unit 102 may be provided with an externally oriented camera 102a, a lidar sensor 102b, a radar sensor 102c, and the like (e.g., an ultrasonic sensor, infrared sensor, thermal imaging sensor, or night-vision camera, etc.), to recognize dynamic and static objects present outside the vehicle 100. The camera 102a may recognize an external object (e.g., vehicle outline, pedestrian silhouette, or roadside barrier shape, etc.) as an image while the vehicle 100 is in use, generate image data, and transmit the image data to the processor 130. The lidar sensor 102b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 102c may emit radio waves of a specific frequency around the vehicle 100 and generate radar data through radio waves reflected from the external object (e.g., other cars, cyclists, traffic signs, or animals, etc.). In the present disclosure, the sensor unit is illustrated as having the lidar sensor 102b, but in other examples, the lidar sensor 102b may not be mounted.

The first sensor unit 102 may generate object recognition information based on sensing data. The object recognition information may include information on the presence or absence of an object, position information about the object, information on a distance between the vehicle 100 and the object, and information on a relative speed between the vehicle 100 and the object (e.g., approaching vehicle, crossing pedestrian, or stopped obstacle, etc.). In the example, the external objects may be various objects related to the operation of the vehicle 100.

A second sensor unit 103 may be provided with a positioning sensor 103a, a wheel sensor 103b, an attitude sensor 103c, and the like (e.g., a GPS receiver, magnetometer, or barometric pressure sensor, etc.), to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle (e.g., yaw drift during a turn, pitch changes on a slope, or roll while cornering, etc.).

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like (e.g., brake fluid temperature, oil pressure level, cabin air quality, or vibration information, etc.).

In addition, the vehicle driving information may include path information. The path information may refer to information generated based on a destination input by a vehicle user through the operating unit 106. The path information may refer to information that indicates a traveling path from a current position of a host vehicle to a destination on a map when the destination has been set (e.g., highway route, shortest local road, toll-free route, or scenic route, etc.). When no destination is set, the path information may refer to information including a road on which the host vehicle is currently traveling and a future driving path including the road (e.g., predicted next intersection, upcoming exit, or estimated continuation on the current lane, etc.).

The operating unit 106 may be configured as a module that is controlled by the user for driving. For example, the operating unit 106 may be a steering wheel for manual driving, an automatic or manual shift transmission, an accelerator pedal, a brake pedal, a clutch pedal, gear lever, or joystick-type controller, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that can be touched on the display 108 (e.g., touchscreen buttons, voice command interface, or gesture-based control, etc.). Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, path/traffic information, remaining energy amount information, content requested by the driver, or the like, of the vehicle 100 by the processor 130 (e.g., displaying navigation maps, real-time fuel/battery status, multimedia content, or vehicle diagnostic alerts, etc.). In addition, the display 108 may be configured as a touch screen capable of detecting a driver's input to receive a driver's request to instruct the processor 130.

The load device 114 is mounted on the vehicle 100 and may be a type of non-driving electrical device not including a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like (e.g., infotainment system, power windows, or onboard refrigerator, etc.). In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, nearby vehicles 300, and the like. The transmitting/receiving unit 112 may include a module that processes, for example, cellular communication, WAVE, DSRC communication, and the like (e.g., 5G-based V2X communication, Bluetooth, or Wi-Fi Direct, etc.). In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100 (e.g., a smartphone, tablet, or wearable device, etc.). In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130 (e.g., red light timing, green light countdown, or priority vehicle signaling, etc.). In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply driving power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, not including components directly involved in driving operations (e.g., entertainment systems, climate control units, or auxiliary safety sensors, etc.). When the vehicle 100 is driven based on electrical energy, the energy generating unit 110 may be configured as an electric battery charged from the outside, or configured as a combination of an electric battery and a fuel cell that charges the electric battery. In the case of a vehicle driven based on the combination of the electric battery and the fuel cell, the energy generating unit 110 may include a tank that stores materials used to produce electric power for the fuel cell, such as liquefied hydrogen (e.g., cryogenic hydrogen, compressed hydrogen, or methanol reforming fuel, etc.). When the vehicle 100 is driven based on fossil energy, the energy generating unit 110 may be configured as an internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 in accordance with a manual operation from the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine (e.g., automatic gearbox, continuously variable transmission (CVT), or dual-clutch transmission, etc.).

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels (e.g., electric power steering, hydraulic steering, or steer-by-wire systems, etc.). When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation system 122 may provide navigation information. The navigation information may include at least one of map information, set destination information, path information according to a set destination, information on various objects on the path, lane information, and current vehicle position information (e.g., toll booth locations, charging stations, rest areas, or accident zones, etc.).

The navigation system 122 may receive information from an external device through the transmitting/receiving unit 112 and update previously stored information. According to the example, the navigation system 122 may be classified as a sub-component of the operating unit 106.

In addition, the vehicle 100 may include a memory 120 and the processor 130.

The memory 120 may store applications and various types of data for controlling the vehicle 100, and load applications or read and record data according to a request from the processor 130 (e.g., storing navigation maps, diagnostic logs, multimedia content, or autonomous driving algorithms, etc.).

The processor 130 may perform overall control of the vehicle 100. The processor 130 may be configured to execute applications and instructions stored in the memory 120 (e.g., path planning software, collision avoidance logic, or driver monitoring algorithms, etc.).

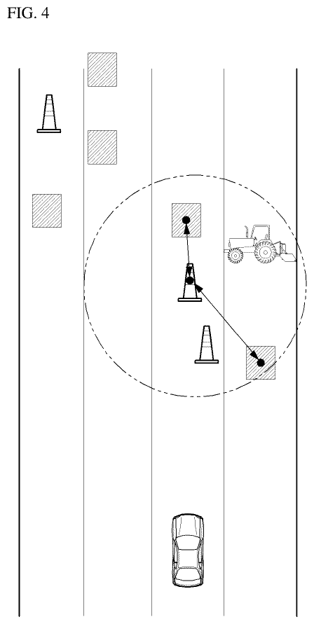

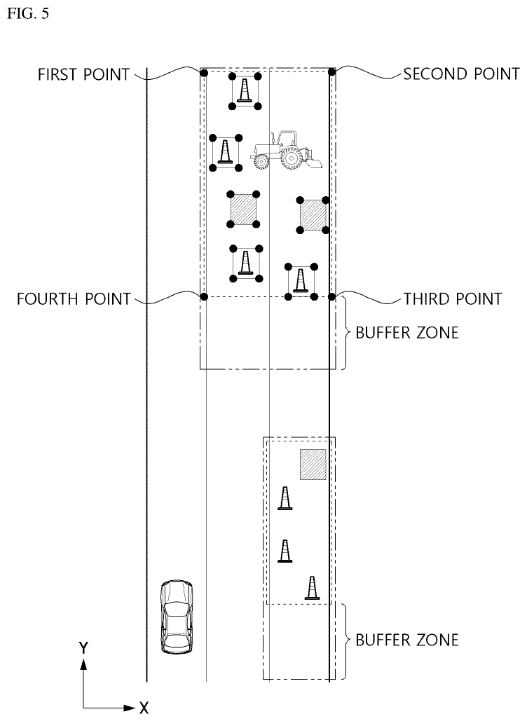

FIG. 3 shows an exemplary operation of an autonomous vehicle control device according to an example.

Sensors 102 and 103 recognize external objects around an autonomous vehicle to generate object recognition information and collect driving data of the host vehicle (the autonomous vehicle) to generate vehicle driving information. The sensors 102 and 103 include the first sensor unit and the second sensor unit of FIG. 2, and each sensor unit is responsible for detecting the external environment and internal state of the vehicle. The first sensor unit is provided with an externally oriented camera, a lidar sensor, a radar sensor, an ultrasonic sensor, an infrared sensor, or the like (e.g., stereo cameras, solid-state lidar, millimeter-wave radar, or thermal cameras, etc.), to recognize dynamic and static objects present outside the vehicle. Here, the camera provides visual data, the lidar sensor provides three dimensional (3D) spatial data, and the radar sensor provides distance and velocity data, and these sensors work complementarily to enable precise object recognition. The sensors 102 and 103 analyze collected sensing data to generate object recognition information, and the object recognition information includes the presence or absence of an object, location information about the object (e.g., X, Y, Z coordinates, latitude/longitude coordinates, or relative position on a map, etc.), distance information between the vehicle and the object, and relative speed information between the vehicle and the object. External objects are various objects related to the operation of the vehicle (e.g., construction structures, other vehicles, pedestrians, bicycles, motorcycles, animals, roadside debris, or traffic signals, etc.), and these are utilized as essential data for autonomous vehicles to adapt to the road environment and travel safely.

The second sensor unit collects sensing data from a positioning sensor, a wheel sensor, and an attitude sensor to monitor a state inside the vehicle and generates vehicle driving information. The positioning sensor identifies a current position of the vehicle through the Global Positioning System (GPS), an inertial measurement unit (IMU), or through combined localization methods (e.g., simultaneous localization and mapping (SLAM), differential GPS, or real-time kinematic positioning, etc.). The wheel sensor measures the rotational speed of the wheels to provide speed data, and the attitude sensor detects changes in the inclination or direction of the vehicle. The vehicle driving information is generated based on data collected from these various sensors, and includes vehicle attitude information (e.g., roll, pitch, yaw angle, or angular velocity, etc.), speed information, incline information, weight information, direction information, battery information, fuel information, tire pressure information, steering information, indoor temperature information, indoor humidity information, pedal position information, engine temperature information, brake pressure information, gear position information, driver seat occupancy information, oil pressure information, or coolant temperature information, etc. Such information reflects a dynamic state of the vehicle in real time, thereby supporting an autonomous driving algorithm in making an optimal driving determination.

In addition, the vehicle driving information includes route information. The route information is generated based on a destination entered by a vehicle user, and is data in which a driving route from a current location of the host vehicle to a destination is shown on a high-definition map (HD Map) when the destination is set. This is calculated using a path planning algorithm provided by the navigation system (e.g., the A* algorithm or Dijkstra algorithm) and reflects geographical data such as road lanes, intersections, speed limits, road curvature, elevation, traffic congestion information, or construction zones, etc. When the destination is not set, the route information includes a road on which the vehicle is currently traveling and a predicted future driving route based on the road. For example, real-time sensor data and pre-learned road network data are combined to dynamically generate a route, which assists the autonomous vehicle in safely traveling even without a destination.

The processor 130 may detect an external object based on the object recognition information and determine a class of the detected external object.

The processor 130 may detect an external object within the road based on the object recognition information collected from the sensors 102 and 103 and determine a class of the detected external object. The object recognition information is data generated from the sensors 102 and 103 and includes the presence or absence of an external object, location information (e.g., X, Y, Z coordinates, bounding box data, or polar coordinates, etc.), distance information between the vehicle and the object, and relative speed information between the vehicle and the object. The processor 130 may receive such object recognition information as an input and perform the role of identifying and classifying the external object (e.g., pedestrian, cyclist, passenger car, truck, bus, traffic cone, guardrail, or traffic sign, etc.).

The processor 130 first analyzes the object recognition information to detect an external object. In this process, the processor 130 processes data within the object recognition information using a deep learning-based object detection algorithm (e.g., YOLOv5, Faster R-CNN). For example, 2D image data collected from the camera and 3D point cloud data collected from the lidar are fused to identify the location and outline of objects on the road.

The processor 130 applies a region proposal technique for object detection, and the region proposal technique may extract a region where an object is likely to exist in the form of a bounding box. For example, lidar data provides 3D coordinates of an object to identify its location, while camera data analyzes visual features (e.g., the color and pattern, shape, or texture, etc.) of the object to refine the boundary of the bounding box. Through this fusion process, the processor 130 detects a dynamic object (e.g., another vehicle, a pedestrian, a cyclist, or an animal, etc.) and a static object (e.g., a construction structure, an obstacle, a guardrail, a traffic sign, or roadside debris, etc.) on the road.

After the external object is detected, the processor 130 determines a class of the detected object. To this end, the processor 130 extracts features of the object within the bounding box using a convolutional neural network (CNN) or a transformer-based classification model (e.g., ResNet, DETR) and classifies the object into one of the pre-learned classes (e.g., vehicle, pedestrian, construction structure, traffic signal, stationary obstacle, traffic light, road cone, or unknown, etc.). Specifically, the processor 130 analyzes attributes of the object, such as visual features (e.g., an orange cone shape of a construction structure, a red triangular stop sign, or a reflective surface pattern, etc.), size, and speed, to predict its class.

For example, when an orange-and-white striped pattern is detected in the camera data and a corresponding object is identified as stationary and occupying the road in the lidar data, the processor 130 classifies the object as a construction structure. If the features of the object are not clearly mapped to training data, the processor 130 determines the object as unknown.

The processor 130 may utilize a deep learning model that has undergone additional training (fine-tuning) to suit the autonomous driving environment in a state in which the deep learning model is pre-trained with a large-scale dataset (e.g., KITTI, COCO) for object detection and classification. Such a model is executed on a high-performance computing device such as a graphics processing unit (GPU), and applies parallel computation and optimizations (e.g., TensorRT) for real-time processing. In addition, the fusion of sensor data is accomplished through probabilistic algorithms such as the Kalman filter, and the fusion may contribute to increasing the accuracy of the estimation of the location and speed of the object (e.g., filtering GPS noise, predicting pedestrian trajectories, or smoothing vehicle velocity estimates, etc.).

The processor 130 may determine construction structure candidates based on class classification results and location information of the external objects. The processor 130 may determine that the external object classified as a construction structure in the class classification result is a reference object.

The processor 130 may determine that the external object classified as the construction structure at a previous point in time is the reference object.

The processor 130 may determine that an external object classified as a stationary object in the class classification result is a construction structure candidate when the external object occupies the road (e.g., blocked lane, narrowed shoulder, or temporary detour, etc.).

The processor 130 may determine, based on information regarding at least one of the size, speed, or road occupancy of an external object classified as an unclassified object in the class classification result, that the unclassified object is the construction structure candidate.

The processor 130 may determine that the unclassified object is the construction structure candidate when the size thereof is less than a reference size, its speed is less than or equal to a reference speed, and the object occupies the road (e.g., small barriers, temporary cones, or equipment left in the lane, etc.).

The processor 130 determines the construction structure candidates based on the class classification results and location information of the external objects. The processor 130 first determines an external object identified as a construction structure among classification results of classes of external objects using the object recognition information received from the sensors 102 and 103, as a reference object. The reference object serves as a reference point in a process of selecting and clustering subsequent construction structure candidates, and serves as a reference point for the autonomous vehicle to accurately recognize a construction zone on the road (e.g., lane closures, temporary barriers, roadside equipment, or traffic cones, etc.).

Taking temporal continuity into account, the processor 130 determines an external object classified as a construction structure at a previous point in time as a reference object. This is to maintain object consistency in an object recognition process performed on a frame-by-frame basis, and the object previously determined to be a construction structure is continuously maintained as the reference object regardless of the class classification results of a current frame. For example, even when an object determined as a construction structure in a previous frame is reclassified as unknown in the current frame, the processor 130 still considers the object as a construction structure (reference object) and performs subsequent processing (e.g., continuing to treat a cone, a barrier segment, or a temporary road sign as part of the construction zone despite intermittent misclassification, etc.).

When the external object classified as the stationary object in the class classification result occupies the road, the processor 130 determines the corresponding object as the construction structure candidate. The stationary object is an object having a speed close to “0” (e.g., V≈0 m/s, parked car, roadside construction barrel, or a concrete block, etc.), and the determination as to whether the object occupies the road is made by combining high-definition map (HD Map) data and 3D point cloud data from the lidar sensor. In this process, the processor 130 checks whether the object is located within a lane and determines whether the object is included in the construction structure candidates.

The processor 130 determines the size and speed of the object by comparing sensor data between consecutive frames, and this may be performed by utilizing a tracking algorithm using optical flow or a Kalman filter (e.g., extended Kalman filter, unscented Kalman filter, or particle filter, etc.).

In addition, the processor 130 may perform a road occupancy determination based on simultaneous localization and mapping (SLAM) technology to maintain consistency between lane information (Lane Link) provided by a high-definition map and real-time sensor data (e.g., lidar-based SLAM, visual SLAM, or graph-based SLAM, etc.).

The processor 130 determines an unclassified object as a construction structure candidate based on information regarding at least one of the size, speed, or road occupancy of the external object classified as the unclassified object in the class classification result. This is a configuration for solving the problem of not being able to avoid the unclassified object, and comprehensively utilizes precision map information and sensor data (e.g., road network graphs, lane geometry data, or geofenced construction regions, etc.).

When the size of the unclassified object is less than a reference size, its speed is less than or equal to a reference speed, and the object occupies the road, the processor 130 may determine that the corresponding unclassified object is the construction structure candidate. For example, the reference size may be defined as the area of the object being less than 0.8 m² (that is, S<0.8 m²), and the reference speed may be set to be less than 0.7 m/s (that is, V≤0.7 m/s). In addition, the processor 130 determines whether the object occupies the road by determining whether the bounding box coordinates of the object are included within a lane boundary (e.g., center lane, shoulder lane, bike lane, or turning lane, etc.). When the size of the unclassified object is less than a reference width, the speed is less than or equal to a reference speed, and the object occupies the road, the processor 130 determines the unclassified object as the construction structure candidate (e.g., small traffic cones, portable barricades, toolboxes, or construction debris, etc.).

The processor 130 may cluster construction structure candidates to determine a construction structure. The processor 130 may determine the similarity with the construction structure candidate based on the object classified as the reference object among external objects (e.g., cones, barriers, guardrails, or barrels, etc.).

The processor 130 may cluster objects having a similarity less than or equal to a preset threshold value to determine that the objects are construction structures.

The processor 130 determines the similarity with the construction structure candidate based on an object classified as a reference object among external objects. The reference object is an object identified as the construction structure in the class classification result or an object determined as the construction structure in the previous frame, and serves as the reference point for construction structure determination (e.g., the first detected cone in a series, a leading barrier, or a previously recognized temporary sign, etc.). The processor 130 clusters objects having a similarity less than or equal to a preset threshold value to determine the objects as construction structures.

The processor 130 analyzes the relationship between the construction structure candidate and the reference object to calculate the similarity. Similarity calculation uses mixed data (numerical data and categorical data) and may apply the Gower similarity technique (e.g., combining Euclidean distance with lane-link relationship or semantic label comparison, etc.). The processor 130 may comprehensively compare different data types (numerical, categorical) based on the following Equation 1.

$$Similarity = \frac{{\sum }_{r = 1}^{p} {W}_{{C}_{r}} {D}_{{C}_{r}}}{{\sum }_{r = 1}^{p} {W}_{{C}_{r}}} \times \frac{{\sum }_{r = 1}^{q} {W}_{{N}_{r}} {D}_{{N}_{r}}}{{\sum }_{r = 1}^{q} {W}_{{N}_{r}}} \qquad [ Equation 1 ]$$

In Equation 1, C represents categorical data, N represents numerical data, p represents the number of pieces of categorical data, and q represents the number of pieces of numerical data. For example, p=1 and q=1. In addition, WCr and WNr represent weights of categorical data and numerical data respectively, and are both set, for example, to 1.

Gower similarity is a distance measurement method designed to comprehensively process various data types, and is suitable for comparing complex relationships (e.g., location, lane information, relative position, lane adjacency, occupancy status, or object category, etc.) between objects in autonomous driving environments.

The processor 130 calculates distance values of categorical data and numerical data as weighted averages, and then multiplies the two values to calculate a final similarity. Specifically, the processor 130 calculates the final similarity by multiplying a value obtained by dividing the sum of the distance values of categorical data by the sum of the weights of categorical data and a value obtained by dividing the sum of the distance values of numerical data by the sum of the weights of numerical data (e.g., assigning equal weights when both categorical and numerical features are considered equally important, or adjusting weights to prioritize lane-link information over raw distance, etc.).

In the example, the numerical data is the distance between the reference object and the construction structure candidates, and the processor 130 calculates the distance between the reference object and the construction structure candidates using the Euclidean distance (L2 Distance) technique. The Euclidean distance technique is a method of calculating a straight-line distance between two points, and in an example, the Euclidean distance may be calculated based on the 3D coordinates (X, Y, Z) of the construction structure class and the construction structure candidates (e.g., cones placed along a lane, barriers forming a boundary, traffic signs positioned on poles, or construction vehicles parked on the roadside, etc.). For example, when the coordinates of the reference object are (X₁, Y₁, Z₁) and the coordinates of the construction structure candidate object are (X₂, Y₂, Z₂), the processor 130 may calculate the distance between the reference object and the construction structure candidate using \sqrt{(X₂−X₁)²+(Y₂−Y₁)²+(Z−Z₁)²}. This value represents a physical distance between two objects, and the closer the distance, the higher the similarity (e.g., cones placed sequentially in a lane, barriers lined along the road, or posts marking roadwork, etc.).

The processor 130 may perform Euclidean distance calculation based on 3D point cloud data of the lidar sensor, and lane link information may be updated in real time through a high-definition map and SLAM technology (e.g., visual SLAM, graph-based SLAM, or lidar-inertial SLAM, etc.).

In the example, the categorical data defines a distance value Dc based on the relationship between the reference object and a lane link occupied by the construction structure candidate. The lane link refers to lane-level connection information provided in the high-definition map, and divides the road occupancy location of an object into lane-level units. For example, the processor 130 may set DC=1 when two objects are located on the same lane link, set DC=1.5 when two objects are located on adjacent lane links, and set DC=2 when two objects are in other lane link relationships (e.g., opposite lanes, merging lanes, or diverging ramps, etc.). The processor 130 reflects the spatial proximity of the lane links through these settings, so that objects located physically closer have higher similarity.

The processor 130 performs clustering based on the calculated similarity. The processor 130 may group objects having a similarity less than or equal to a specific value based on the reference object into one cluster. For example, the processor 130 may perform clustering using a density-based clustering algorithm such as density-based spatial clustering of applications with noise (DBSCAN) or alternatives (e.g., OPTICS, HDBSCAN, or k-means variants, etc.).

The processor 130 finally outputs all construction structure candidate objects belonging to one cluster as construction structures based on a clustering result. This reclassifies unclassified objects as construction structures, and the construction structures are used in subsequent stages to generate construction zones and plan avoidance routes (e.g., adjusting driving paths, initiating lane changes, or reducing vehicle speed, etc.). The clustering algorithm utilizes GPU parallel computing for large-scale data processing, and the GPU parallel computing may ensure performance in real-time autonomous driving environments (e.g., handling millions of lidar points per second, processing multi-camera streams, or integrating radar reflections, etc.).

In addition, the processor 130 may dynamically adjust a similarity threshold value during the clustering process. The processor 130 may adjust the similarity threshold value by adaptively changing the sensitivity of clustering depending on the complexity of the road environment (e.g., the density of construction zones, a number of adjacent vehicles, or the variety of roadside objects, etc.). In this way, it is possible to technically reinforce the accuracy of determining whether an unclassified object is a construction structure and to support an autonomous vehicle in reliably recognizing and avoiding construction zones in various road environments (e.g., highways, urban roads, intersections, or tunnels, etc.).

The processor 130 may generate a virtual construction zone and an avoidance zone based on the construction structures. The processor 130 may generate a virtual construction zone covering the construction structure using the construction structure as the reference point and generate an avoidance zone with a buffer zone set in the virtual construction zone (e.g., extended safe region, restricted driving region, or temporary detour space, etc.).

The processor 130 generates the virtual construction zone based on the construction structures belonging to each cluster. The construction structures are objects grouped together through clustering, and the processor 130 uses location information about these objects to define the construction zone. Specifically, the processor 130 generates box points of the construction zone by extracting minimum (min) and maximum (max) values of bounding box coordinates of the construction structures and the construction structure candidates based on the host vehicle. The construction zone box consists of four points. For example, the processor 130 sets a minimum X coordinate and a maximum Y coordinate of all objects of the construction structures as a first point, sets a maximum X coordinate and a maximum Y coordinate as a second point, sets the maximum X coordinate and the minimum Y coordinate as a third point, and sets the minimum X coordinate and the minimum Y coordinate as a fourth point. The four points form a minimum rectangular region covering all construction structures, and the processor 130 defines the rectangular region as a virtual construction zone (e.g., rectangular bounding area covering cones, barriers, barrels, or temporary fences, etc.).

In addition, the processor 130 checks a lane occupied by the construction structure and sets the corresponding lane as the occupied lane of a construction zone object. Lane information is based on lane link data provided in the high-definition map, and in the lane information, the construction zone is set to match an actual road situation (e.g., lane closure due to roadworks, narrowing of lanes near an overpass, merging zone near intersections, or blocked shoulder lane, etc.).

The processor 130 generates a virtual construction zone, then sets a buffer zone according to the road speed limit to expand the construction zone, and generates the expanded zone as an avoidance zone. The buffer zone is designed to provide additional space at a boundary of the construction zone so that the autonomous vehicle maintains a safe distance from the construction structure (e.g., cones, barriers, warning signs, or equipment vehicles, etc.). The processor 130 sets the buffer zone, which is divided into a longitudinal buffer zone and a lateral buffer zone. For example, the processor 130 sets the longitudinal buffer zone according to the road speed limit and sets the lateral buffer zone based on a preset distance value (e.g., 0.3 m, 0.5 m, or 1 m on each side, depending on lane width, etc.).

The processor 130 generates an extended region by adding the longitudinal buffer zone and the lateral buffer zone at the boundary of the construction zone, and generates this region as the avoidance zone. For example, when a longitudinal length of the construction zone is 10 m and a speed limit is 80 km/h, a longitudinal buffer zone of 30 m is added, so that the total longitudinal length is 70 m (10 m+30 m+30 m). In a lateral direction, 0.3 m is added on each side, so that a width of the construction zone is increased by 0.6 m (e.g., from 2.5 m to 3.1 m, from 3 m to 3.6 m, or from 3.5 m to 4.1 m, etc.).

The processor 130 may adjust the buffer zones by considering the dynamic characteristics of the host vehicle (e.g., braking distance, steering response speed, or tire grip, etc.) and the road environment (e.g., speed limit, lane width, road curvature, or surface condition, etc.).

The processor 130 may determine a response action of the autonomous vehicle depending on the avoidance zone.

The processor 130 may determine the response action of the vehicle based on the vehicle driving information and the avoidance zone (e.g., biased driving, lane encroachment, or lane change, etc.).

The processor 130 establishes a driving strategy for the host vehicle to safely pass through the construction zone based on the avoidance zone, and to this end, comprehensively analyzes the vehicle driving information and avoidance zone data. The vehicle driving information includes real-time sensor data, such as the location, speed, direction, and lane occupancy state of the host vehicle, and route information, and the avoidance zone is defined as a region where a buffer zone is applied to a construction zone (e.g., extended rectangular area including safety margins, temporary detour route, or restricted maneuvering space, etc.).

The processor 130 may extract the lane boundary by fusing camera and lidar data, and determine biased driving and lane change actions by applying a path planning algorithm (e.g., the A* algorithm) based on a dynamic model (e.g., steering angle, acceleration, deceleration, or wheelbase geometry, etc.) of the host vehicle.

The processor 130 first determines whether lane encroaching is needed to determine the response action. In this process, the processor 130 evaluates whether lane change is possible using presence or absence of an avoidance object in an adjacent lane and the speed of an object in the adjacent lane. The avoidance object is a construction structure, vehicle, or obstacle located in the adjacent lane, and the speed of the object is estimated using the radar sensor or consecutive frame analysis (e.g., optical flow, radar Doppler shift, or lidar tracking, etc.). For example, when there is a stationary object having a speed of 0 m/s in the adjacent lane, lane encroaching is considered a difficult situation (e.g., parked vehicle, immovable barrier, or heavy equipment, etc.).

The processor 130 responds with biased driving when it is possible to respond to the avoidance zone in a host lane. Biased driving is a driving method in which the host vehicle moves slightly laterally to avoid the avoidance zone in the current lane and is performed in a range that does not encroach on the lane boundary (e.g., shifting 0.2 m to the left, 0.5 m to the right, or maintaining offset while still within lane markings, etc.). On the other hand, when it is not possible to avoid the avoidance zone in the host lane, the processor 130 responds with lane encroaching bias or lane change. Lane encroaching bias is driving in a manner in which a portion of the host vehicle moves into an adjacent lane, and a lane change is driving in a manner in which the host vehicle moves completely into an adjacent lane.

The processor 130 responds with lane encroaching bias when more than half of the host vehicle does not cross over to the adjacent lane. This is a situation where partial encroaching into the adjacent lane occurs within a range that does not exceed half of the length or width of the vehicle, based on a body size of the host vehicle. For example, when the width of the host vehicle is 2 m, a case where the vehicle crosses into the adjacent lane by less than 1 m is classified as lane encroachment deviation (e.g., straddling lane markings, partial offset, or squeezing past an obstacle, etc.). Conversely, when more than half of the host vehicle crosses into the adjacent lane, the processor 130 responds with a lane change. This is a situation where more than half of the body of the host vehicle is located in the adjacent lane, requiring a full lane change (e.g., overtaking a barrier, bypassing a parked truck, or merging into a detour lane, etc.).

The processor 130 determines a direction of the response action using object information about the left and right lanes. The object information about the left and right lanes includes the location, speed, size, and the like of the avoidance object in the adjacent lane, and is updated in real time by combining the high-definition map and the sensor data. For example, when a fast vehicle exists in the left lane and the right lane is empty, the processor 130 preferentially selects a lane change to the right (e.g., avoiding collision risk, minimizing disruption to fast-moving traffic, or ensuring smoother merging, etc.). In this process, the processor 130 calculates an optimal direction and timing by considering the current speed of the host vehicle and the distance to the avoidance zone (e.g., adjusting decision when host vehicle speed is 60 km/h vs. 100 km/h, or when avoidance zone is 20 m away vs. 50 m away, etc.).

The processor 130 may generate a driving route of an autonomous vehicle by reflecting the response action. The processor 130 may display the generated vehicle driving route through the display 108 (e.g., graphical interface, heads-up display, or remote monitoring dashboard, etc.).

The processor 130 calculates a path for the host vehicle to safely pass through the construction zone and avoidance zone based on response actions including biased driving, lane encroaching biased driving, or a lane change (e.g., shifting within the lane, partially entering an adjacent lane, or fully moving to the next lane, etc.). In addition, the processor 130 displays the generated driving route through the display 108 so that a vehicle user or system operator may visually check the route. The display 108 may be a screen mounted inside the vehicle (e.g., a center console display, instrument cluster screen, or a heads-up display, etc.) or a screen connected to a remote monitoring system, and the driving route is displayed using graphic elements such as lanes, avoidance zones, and route lines (e.g., colored overlays, dotted lines, or highlighted zones, etc.).

In the example, the processor 130 may generate the route based on a path planning algorithm (e.g., the RRT, A* algorithm) and calculate an optimal route by considering dynamic constraints of the vehicle (e.g., maximum steering angle, acceleration limit, braking capacity, or minimum turning radius, etc.). In addition, the processor 130 generates a curved route by utilizing a spline or a Bezier curve (e.g., cubic spline, B-spline, or quadratic Bezier curve, etc.).

When the response action is biased driving or lane encroaching biased driving, the processor 130 generates a route that reflects the response action. First, the processor 130 determines a biased lateral offset for biased driving. The biased lateral offset is a distance the host vehicle must move laterally from the center of the host lane to avoid the avoidance zone, and is calculated by considering a boundary of the avoidance zone and the width of the host vehicle. For example, when the avoidance zone is 1 m away from a left boundary of the host lane and the width of the host vehicle is 2 m, the processor 130 sets the lateral offset so that the host vehicle moves about 0.5 m to the right (e.g., shifting left or right by 0.2 m, 0.5 m, or 1 m depending on lane geometry, etc.). Next, the processor 130 determines a bias maintenance distance. The bias maintenance distance is a distance that the vehicle travels straight while maintaining a biased state, and is calculated based on the longitudinal length of the avoidance zone and the speed of the host vehicle. For example, when the length of the avoidance zone is 10 m and the speed of the host vehicle is 50 km/h, the processor 130 sets the host vehicle to maintain the biased state for approximately 0.72 seconds (10 m÷50 km/h×3600/1000) (e.g., bias maintained for 0.5 s, 1 s, or longer depending on road length, etc.).

The processor 130 outputs a bias route reflecting the calculated lateral offset and maintenance distance. The processor 130 generates the bias route from the center of the host lane to a bias target point. The center of the host lane is a centerline of the current lane, and the bias target point is a point moved by the lateral offset. This route is generated as a curved route and is designed to move smoothly in consideration of the steering dynamics of the host vehicle (e.g., minimum turning radius, or steering angle rate, etc.).

In addition, the processor 130 generates a straight route reflecting the bias maintenance distance. This is a route along which the host vehicle travels straight while maintaining a constant lateral position as the host vehicle passes through the avoidance zone from a biased position, and its length is determined according to the longitudinal length of the avoidance zone (e.g., 5 m, 10 m, or 20 m depending on road layout, etc.).

In addition, the processor 130 generates a route that returns to the center of the host lane from a bias end point. The bias end point is a point where the passage through the avoidance zone is completed, and the return route is a curved route that returns to the center of the host lane again and is designed to return to the center of the lane while maintaining vehicle stability (e.g., smoothing steering input, minimizing lateral acceleration, or preventing abrupt oscillations, etc.).

The processor 130 outputs a lane change route when the response action is a lane change. The lane change route is a route that allows the host vehicle to move completely from the current lane to the adjacent lane, and is generated as a curved route that crosses the lane boundary. In this process, the processor 130 calculates the route to allow the lane change by considering the speed and steering angle of the host vehicle, and traffic conditions in the adjacent lane (e.g., presence of fast vehicles, stationary obstacles, or motorcycles, etc.). In addition, the processor 130 determines whether it is necessary to return to an original lane using global route information after passing through the avoidance zone. The global route information is a destination route provided from the high-definition map and vehicle driving information, and the original lane is a lane in which the host vehicle was traveling before the lane change. For example, when the destination route follows the original lane, a return is considered necessary (e.g., continuing straight after passing barriers, merging back after a detour, or aligning with navigation path, etc.). The processor 130 outputs a return route when the return to the original lane is necessary. The return route is a curved route from the adjacent lane back to the original lane, is generated in a manner similar to the lane change route, and reflects the surrounding traffic conditions and the dynamics of the host vehicle.

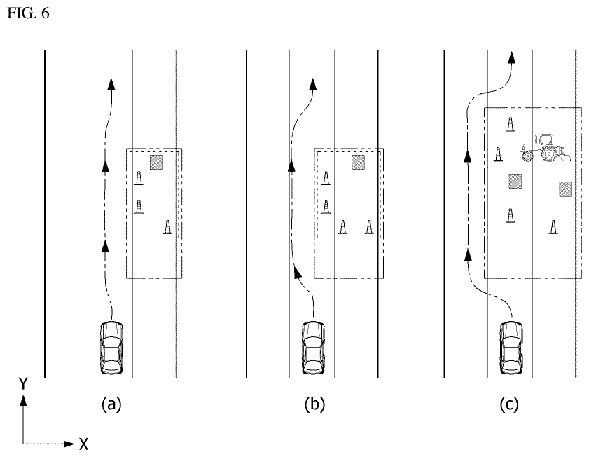

FIG. 4, FIG. 5, FIG. 6, and FIG. 7 show exemplary operations of the processor according to the example. Referring to FIG. 4, an autonomous vehicle and objects related to construction structures are disposed on a road. A circle is marked on the road, and reference objects (cones) and construction structure candidates (rectangular boxes) are included in the circle. Outside the circle, additional construction structure candidates (rectangular boxes) are distributed, which suggests that the construction structure candidates are targets for similarity calculation and targets for clustering (e.g., cones further away, barriers in adjacent lanes, or road markers, etc.).

In FIG. 4, the circle represents a clustered group, which visualizes a cluster composed of objects whose similarity is less than or equal to a preset threshold value. The circle represents a result formed by a density-based clustering algorithm such as DBSCAN (e.g., or alternative clustering methods like OPTICS or HDBSCAN, etc.), and contains objects that are ultimately determined as construction structures.

The circle is located inside road lanes, and the objects contained within the circle may form one construction zone (e.g., a sequence of cones, barriers forming a boundary, or equipment aligned along the lane, etc.). A boundary of the circle is highlighted with a dotted or solid line to make a clustering result visually clear.

A highlighted cone in the circle represents a reference object. This is an object identified as a construction structure as a result of class classification or determined as construction structures in the previous frame, and serves as a basis for determining the similarity (e.g., first detected cone, main barrier element, or key traffic control device, etc.).

The reference object is distinguished from rectangular boxes and is contained inside a bounding box in which location coordinates (e.g., X, Y, Z, latitude/longitude, or polar coordinates, etc.) based on the 3D point cloud data of the lidar sensor and high-definition map data are reflected.

The rectangular boxes represent construction structure candidates. These are objects selected from among stationary objects or unclassified objects, and are the targets for similarity calculation (e.g., cones, barriers, barrels, or temporary roadside equipment, etc.).

The rectangular boxes inside the circle represent the construction structure candidates included in the clustering, and the external rectangular boxes visualize the construction structure candidates that have not yet been evaluated or whose similarity exceeds a threshold value. Each rectangular box is represented as a bounding box that reflects the size and position of the object (e.g., length, width, height, and orientation, etc.).

Referring to FIG. 5, a dotted rectangle represents a virtual construction zone and is defined as a minimum rectangular region covering construction structures. The construction zone is generated using minimum (min) and maximum (max) values of the coordinates of the bounding box of the construction structures (e.g., cones, barriers, barrels, or fences, etc.).

Specifically, the construction zone box is generated based on the coordinates of the construction structures, that is, a first point (a minimum X coordinate and a maximum Y coordinate), a second point (a maximum X coordinate and the maximum Y coordinate), a third point (the maximum X coordinate and a minimum Y coordinate), and a fourth point (the minimum X coordinate and the minimum Y coordinate) (e.g., forming four corners of a rectangular polygon on the map, etc.).

In FIG. 5, a solid line rectangle represents an avoidance zone, which is generated by adding a buffer zone to the dotted line rectangle. The buffer zone is set according to the road speed limit, for example, a longitudinal buffer zone is set to 20 m when the road speed limit is 70 km/h or less, and 30 m when the road speed limit is 80 to 90 km/h. A lateral buffer zone is fixed at 0.3 m (e.g., 0.5 m, 1 m, or dynamically adjustable based on lane width, etc.).

For example, when the longitudinal length of the construction zone is approximately 10 m, the buffer zone of 30 m is added when the speed limit is 80 km/h, so that a longitudinal avoidance zone of a total of 40 m is generated. A buffer zone of 0.3 m is added in a lateral direction, so that the width is increased by 0.3 m. Alternatively, a buffer zone of 0.3 m is added on both sides in the lateral direction, so that the width is increased by 0.6 m (e.g., from 3.0 m to 3.6 m, or from 3.5 m to 4.1 m, etc.).

Referring to FIG. 6A, FIG. 6B, and FIG. 6C, a process of generating a response action centered on an avoidance zone by an autonomous vehicle is visualized. FIG. 6A represents an initial situation, FIG. 6B represents a biased driving situation, and FIG. 6C represents a lane change situation. In FIGS. 6A to 6C, solid line rectangles (the avoidance zone) and dotted line rectangles (the construction zone) cover construction structures, and arrows visualize response actions of the autonomous vehicle (e.g., shifting laterally, partial lane overlap, or full lane change, etc.).

In FIG. 6A, the autonomous vehicle is positioned in a center lane, and the processor prepares a response action as the avoidance zone partially encroaches into the driving lane. The processor determines a response action to perform biased driving in the driving lane in proportion to the avoidance zone encroaching into the driving lane (e.g., offset by 0.2 m, 0.5 m, or 0.8 m, etc.).

In FIG. 6B, the autonomous vehicle is positioned in the center lane, and the processor prepares a response action as the avoidance zone encroaches into the driving lane by a certain amount or more. The processor determines a response action to perform biased driving by partially entering a left lane in proportion to the size of the avoidance zone encroaching into the driving lane. The arrow indicates a curved route that avoids the avoidance zone by moving to the left (lateral offset) from the center of the driving lane. This refers to a situation where biased driving is possible, and refers to lane encroaching biased driving where the host vehicle does not cross more than half of its body into the adjacent lane (e.g., encroaching 0.5 m into the next lane when vehicle width is 2 m, etc.).

In FIG. 6C, the autonomous vehicle is positioned in the center lane, and the processor prepares a response action as the avoidance zone mostly encroaches into the driving lane. The processor determines a response action for changing lanes so that the autonomous vehicle fully moves into the left lane. The arrow shows a route along which the autonomous vehicle moves into the left lane and then travels straight ahead (e.g., full lane change to avoid blocked road, merging into detour lane, or bypassing heavy machinery, etc.). This lane change is a situation where a lane change is determined as the response action, due to a state in which the response within the host lane is not possible.

Referring to FIG. 7, the autonomous vehicle is traveling in the center lane, and the arrow shows a curved route for avoiding the avoidance zone by moving to the left lane by an offset distance between a start point and the end point in the driving lane. This is a situation where the processor determines the lane encroaching biased driving as the response action, and corresponds to a case where more than half of the host vehicle does not cross into the adjacent lane (e.g., lateral shift of less than 1 m for a 2 m-wide car, etc.).

The autonomous vehicle continues to travel in the center lane to avoid the avoidance zone, but travels straight along the center lane and then returns to the driving lane after performing bias driving in the avoidance zone (e.g., shifting left, maintaining offset, and then re-centering in lane, etc.).

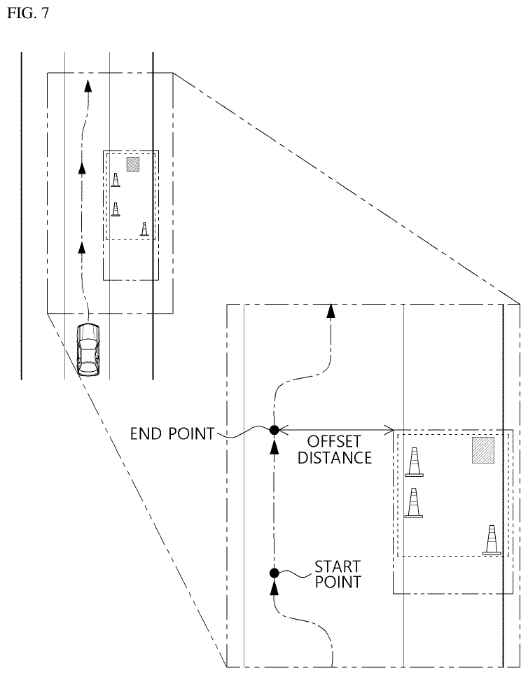

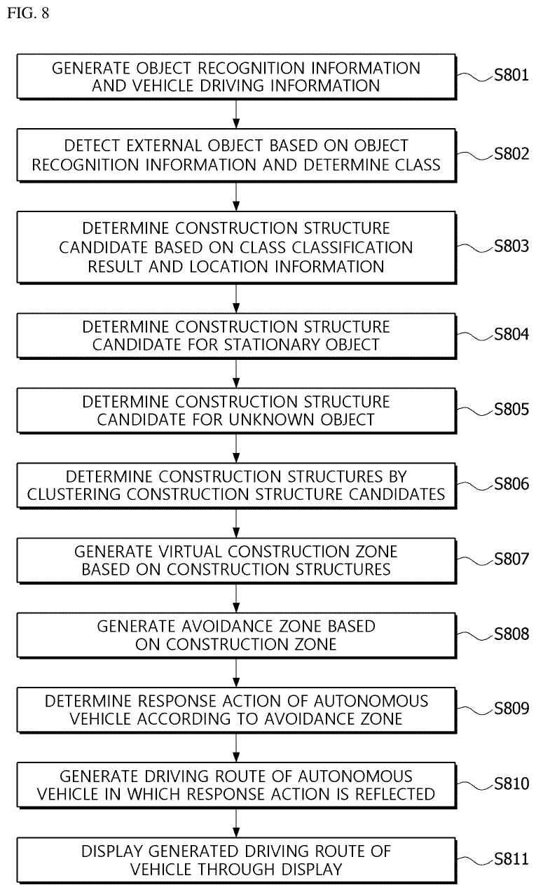

FIG. 8 shows an example of a method of controlling an autonomous vehicle according to an example. Referring to FIG. 8, a sensor is a detection device mounted on an autonomous vehicle that recognizes external objects to generate object recognition information and collects driving data of a host vehicle (the autonomous vehicle) to generate vehicle driving information. The object recognition information includes the presence or absence of an external object, location coordinates (e.g., X, Y, Z, GPS coordinates, or relative grid position, etc.), the distance from the vehicle, the relative speed, and the like, and is derived from data collected from a camera, a lidar, a radar, an ultrasonic sensor, an infrared sensor, or other perception devices, etc. The vehicle driving information includes the attitude, speed, direction, lane occupancy state, and the like of the host vehicle, and is generated based on data collected from a positioning sensor, a wheel sensor, and an attitude sensor (S801) (e.g., IMU, gyroscope, magnetometer, or accelerometer, etc.).

Next, the processor detects an external object based on the object recognition information received from the sensor and determines the class of the detected external object. In this process, the processor uses a deep learning model to generate a bounding box of the object and classifies the object as a construction structure, a vehicle, an unknown object, or the like through the CNN (S802) (e.g., ResNet, YOLO, DETR, or MobileNet, etc.).

Next, the processor determines construction structure candidates based on the class classification results and location information of the external objects. The processor determines the external object classified as the construction structure in the class classification result as a reference object, and also considers the external object classified as the construction structure at a previous point in time (e.g., a previous frame, a historical track, or a temporarily stored reference object, etc.) as the reference object. This maintains temporal consistency, thereby increasing the reliability of the determination of construction structures (S803).

Next, when the external object classified as a stationary object in the class classification result occupies the road, the processor determines the corresponding object as the construction structure candidate. Road occupancy is determined by combining lane link data from the high-definition map and 3D point cloud data from the lidar sensor (S804) (e.g., verifying whether an object blocks the driving lane, shoulder, or ramp, etc.).

In addition, the processor determines the corresponding unclassified object as the construction structure candidate based on information regarding at least one of the size, speed, or road occupancy of the external object classified as the unclassified object in the class classification result. For example, when the size of the unclassified object is less than a reference size (less than 0.8 m²), the speed is less than or equal to a reference speed (less than 0.7 m/s), and the object occupies the road, the processor includes the corresponding object as the construction structure candidate (S805) (e.g., small cones, temporary signs, or toolboxes, etc.).

Next, the processor clusters the construction structure candidates to determine construction structures. The processor determines the similarity between the construction structure candidate and the external object classified as the reference object, and uses the Gower similarity technique for this purpose. The similarity is calculated by combining numerical data (Euclidean distances between the reference object and the construction structure candidates) and categorical data (the lane link relationship), and objects having the similarity less than or equal to a preset threshold value are clustered and finally determined as construction structures (S806) (e.g., cones aligned along the same lane, barriers grouped side by side, or signs in adjacent lanes, etc.).

Next, the processor generates a virtual construction zone based on the determined construction structures. The processor generates the virtual construction zone covering the construction structures using the construction structures as reference points, and to this end, defines four box points by utilizing a minimum X value, a maximum X value, a minimum Y value, and a maximum Y value based on the host vehicle among bounding box coordinates of the construction structures and candidates in each cluster. In addition, the processor sets the occupied lane of the construction structures to the occupied lane of the construction zone (S807) (e.g., leftmost lane, center lane, right lane, or shoulder lane, etc.).

Next, the processor generates an avoidance zone by setting a buffer zone according to the road speed limit. For example, a longitudinal buffer zone is set to 20 m when the speed limit is 70 km/h or less, and 30 m when the speed limit is 80 to 90 km/h, and a lateral buffer zone is fixed at 0.3 m (e.g., expanded to 0.5 m or 1 m for safety in narrow lanes, etc.). The processor generates a region reflecting the buffer zone as the avoidance zone (S808).

Next, the processor determines a response action of the autonomous vehicle according to the avoidance zone. The processor establishes the response actions based on vehicle driving information (e.g., the speed and location of the host vehicle, steering angle, or acceleration of the host vehicle, etc.) and avoidance zone data, and determines whether lane encroaching is needed. To this end, the processor analyzes the presence of an avoidance object in an adjacent lane and the speeds of the objects (e.g., fast vehicles, motorcycles, or buses in adjacent lanes, etc.). When response in the host lane is possible, the processor responds with biased driving, and when not, the processor responds with a lane encroaching bias or lane change. The processor determines the lane encroaching bias when more than half of the host vehicle does not cross into the adjacent lane, and the lane change when more than half of the vehicle crosses into the adjacent lane, and selects a direction using object information in the left and right lanes (S809) (e.g., empty right lane, congested left lane, or balanced choice, etc.).

Next, the processor generates a driving route of the autonomous vehicle by reflecting the response action. In the case of the biased driving, the processor determines the biased lateral offset and the maintenance distance to sequentially generate a biased route from the center of the host lane to a bias target point, a straight route in which the bias maintenance distance is reflected, and a return route from a bias end point to the center of the host lane. In case of the lane change, the processor outputs a lane change route, determines whether a return to the original lane is needed through global path information after the avoidance zone, and generates a return route when needed (S810) (e.g., rejoining original lane after temporary detour, etc.).

Next, the processor displays the generated driving route of the vehicle through the display (S811) (e.g., navigation screen, augmented reality overlay, or remote operator interface, etc.).

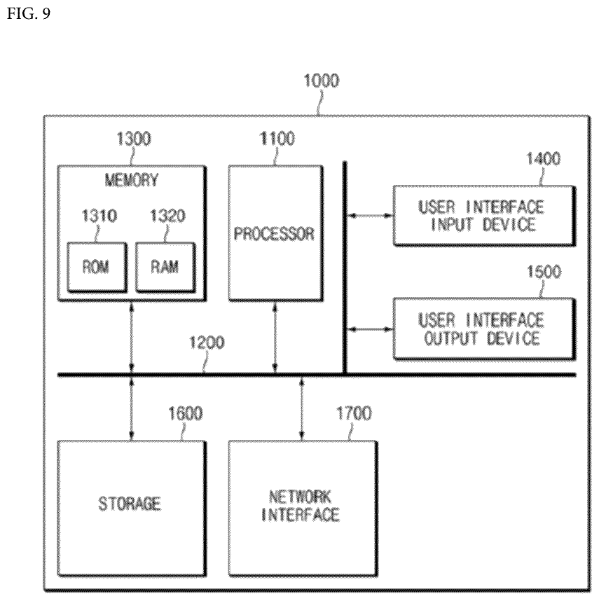

FIG. 9 shows an example computing system (e.g., a computing device of a vehicle or any other apparatus). One or more controllers, processors, etc. described herein, such as one or more components of the vehicle 100 (e.g., DCCU), one or more components of the management server 200, one or more components of the user terminal 300, and any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

### EXAMPLE

According to an example of the present disclosure, there is provided an autonomous vehicle control device including one or more sensors, one or more processors coupled to the one or more sensors, and a memory storing one or more programs executed by the one or more processors, in which the sensor is configured to recognize an external object to generate object recognition information and collect driving data of a host vehicle to generate vehicle driving information, and the processor is configured to detect the external object based on the object recognition information and determine a class of the detected external object, determine construction structure candidates based on a class classification result and location information of the external object, determine a construction structure by clustering the construction structure candidates, generate a virtual construction zone and an avoidance zone based on the construction structure, determine a response action of an autonomous vehicle according to the avoidance zone, and generate a driving route of the autonomous vehicle by reflecting the response action.

The processor may determine an external object classified as the construction structure in the class classification result as a reference object.

The processor may determine an external object classified as the construction structure at a previous point in time as a reference object.

When an external object classified as a stationary object in the class classification result occupies a road, the processor may determine that the external object is the construction structure candidate.

The processor may determine, based on information regarding at least one of a size, speed, or road occupancy of an external object classified as an unclassified object in the class classification result, that the unclassified object is the construction structure candidate.

The processor may determine that the unclassified object is the construction structure candidate when the size of the unclassified object is less than a reference size, the speed is less than or equal to a reference speed, and the unclassified object occupies a road.

The processor may determine a similarity with the construction structure candidate based on an object classified as a reference object among the external objects.

The processor may cluster objects having the similarity less than or equal to a preset threshold value to determine that the objects are construction structures.

The processor may generate the virtual construction zone covering the construction structure using the construction structure as a reference point and generate the avoidance zone with a buffer zone set in the virtual construction zone.

The processor may determine the response action of the vehicle based on the vehicle driving information and the avoidance zone.

According to another example of the present disclosure, there is provided an autonomous vehicle control method that is performed by a computing device including one or more sensors, one or more processors coupled to the one or more sensors, and a memory storing one or more programs executed by the one or more processors, including recognizing, by the sensor, an external object to generate object recognition information and collecting driving data of a host vehicle to generate vehicle driving information, detecting, by the processor, the external object based on the object recognition information and determining a class of the detected external object, determining, by the processor, construction structure candidates based on a class classification result and location information of the external object, determining, by the processor, a construction structure by clustering the construction structure candidates, generating, by the processor, a virtual construction zone and an avoidance zone based on the construction structure, determining, by the processor, a response action of an autonomous vehicle according to the avoidance zone, and generating, by the processor, a driving route of the autonomous vehicle by reflecting the response action.

The determining of the construction structure candidates may include determining an external object classified as the construction structure in the class classification result as a reference object.

The determining of the construction structure candidates may include determining an external object classified as the construction structure at a previous point in time as a reference object.

The determining of the construction structure candidates may include determining, when an external object classified as a stationary object in the class classification result occupies a road, that the external object is the construction structure candidate.

The determining of the construction structure candidates may include determining, based on information regarding at least one of a size, speed, or road occupancy of an external object classified as an unclassified object in the class classification result, that the unclassified object is the construction structure candidate.

The determining of the construction structure candidates may include determining that the unclassified object is the construction structure candidate when the size of the unclassified object is less than a reference size, the speed is less than or equal to a reference speed, and the unclassified object occupies a road.

The determining of the construction structure may include determining a similarity with the construction structure candidate based on an object classified as a reference object among the external objects.

The determining of the construction structure may include clustering objects having the similarity less than or equal to a preset threshold value to determine that the objects are construction structures.

The generating of the virtual construction zone and the avoidance zone may include generating the virtual construction zone covering the construction structure using the construction structure as a reference point and generating the avoidance zone with a buffer zone set in the virtual construction zone.

The determining of the response action of the vehicle may include determining the response action of the vehicle based on the vehicle driving information and the avoidance zone. With an autonomous vehicle control device and method according to an example, it is possible to allow an autonomous vehicle to accurately recognize construction structures on a road and generate a safe driving route based on the recognition.

In addition, it is possible to stably identify construction structures even amid real-time environmental changes.

It is also possible to more accurately identify potential obstacles on the road.

In addition, it is possible to adapt to the road environment in real time by determining a response action to travel while maintaining a safe distance from construction structures and generating a driving route reflecting the response action.

Although the preferred examples of the present disclosure have been described above, it is understood that those skilled in the art can make various changes and modifications to the present disclosure without departing from the spirit and scope of the present disclosure set forth in the claims below.

What is claimed is:

1. An apparatus of a vehicle, the apparatus comprising:
one or more sensors configured to obtain:
object recognition information associated with at least one external object in a surrounding environment of the vehicle, and
driving information of the vehicle;
one or more processors coupled to the one or more sensors; and
a memory storing instructions that, when executed by the one or more processors, are configured to cause the apparatus to:
detect, based on the object recognition information, the at least one external object,
determine a class of the at least one detected external object,
based on the determined class and location information of the at least one detected external object, identify a plurality of construction structure candidates,
determine a construction structure by clustering the plurality of construction structure candidates,
generate, based on the construction structure, a virtual construction zone and an avoidance zone,
determine, based on the avoidance zone, a response action of the vehicle,
output, based on the response action, a signal indicating a driving route of the vehicle, and
control, based on the signal, autonomous driving of the vehicle.

2. The apparatus of claim 1, wherein the instructions, when executed by the one or more processors, are configured to cause the apparatus to determine the at least one detected external object as a reference object, based on the at least one detected external object being classified as the construction structure.

3. The apparatus of claim 1, wherein the instructions, when executed by the one or more processors, are configured to cause the apparatus to determine the at least one detected external object as a reference object, based on the at least one detected external object being classified as the construction structure at a previous point in time.

4. The apparatus of claim 1, wherein the instructions, when executed by the one or more processors, are configured to cause the apparatus to, based on the at least one detected external object being classified as a stationary object and occupying a road, determine that the at least one detected external object is one of the plurality of construction structure candidates.

5. The apparatus of claim 1, wherein the instructions, when executed by the one or more processors, are configured to cause the apparatus to, based on information associated with at least one of a size of the at least one detected external object, a speed of the at least one detected external object, or road occupancy of the at least one detected external object, determine that the at least one detected external object is one of the plurality of construction structure candidates, and wherein the at least one detected external object is classified as an unclassified object.

6. The apparatus of claim 5, wherein the instructions, when executed by the one or more processors, are configured to cause the apparatus to determine that the unclassified object is one of the plurality of construction structure candidates based on:
a size of the unclassified object being less than or equal to a reference size,
a speed of the unclassified object being less than or equal to a reference speed, and
the unclassified object occupying a road.

7. The apparatus of claim 1, wherein the instructions, when executed by the one or more processors, are configured to cause the apparatus to determine a similarity between a construction structure candidate and a reference object, wherein an object among the at least one detected external object is classified as the reference object, and wherein the construction structure candidate is one of the plurality of construction structure candidates.

8. The apparatus of claim 7, wherein the instructions, when executed by the one or more processors, are configured to cause the apparatus to:
based on the similarity being less than or equal to a preset threshold value, cluster the construction structure candidate with the reference object, and
determine that the construction structure candidate clustered with the reference object is a construction structure.

9. The apparatus of claim 1, wherein the instructions, when executed by the one or more processors, are configured to cause the apparatus to:
based on setting the construction structure as a reference point, generate the virtual construction zone covering the construction structure, and
generate the avoidance zone by adding a buffer zone to the virtual construction zone.

10. The apparatus of claim 1, wherein the instructions, when executed by the one or more processors, are configured to cause the apparatus to determine the response action of the vehicle further based on the driving information.

11. A method performed by an apparatus of a vehicle, the method comprising:
obtaining, from a sensor,
object recognition information associated with at least one external object in a surrounding environment of the vehicle, and
driving information of the vehicle;
detecting, based on the object recognition information, the at least one external object;
determining a class of the at least one detected external object;
based on the determined class and location information of the at least one external object, determining a plurality of construction structure candidates;
determining a construction structure by clustering the plurality of construction structure candidates;
generating, based on the construction structure, a virtual construction zone and an avoidance zone;
determining, based on the avoidance zone, a response action of the vehicle; outputting, based on the response action, a signal indicating a driving route of the vehicle; and
controlling, based on the signal, autonomous driving of the vehicle.

12. The method of claim 11, wherein the determining of the plurality of construction structure candidates comprises determining the at least one detected external object as a reference object, based on the at least one detected external object being classified as the construction structure.

13. The method of claim 11, wherein the determining of the plurality of construction structure candidates comprises determining the at least one detected external object as a reference object, based on the at least one detected external object being classified as the construction structure at a previous point in time.

14. The method of claim 11, wherein the determining of the plurality of construction structure candidates comprises, based on the at least one detected external object being classified as a stationary object and occupying a road, determining that the at least one detected external object is one of the plurality of construction structure candidates.

15. The method of claim 11, wherein the determining of the plurality of construction structure candidates comprises, based on information associated with at least one of a size of the at least one detected external object, a speed of the at least one detected external object, or road occupancy of the at least one detected external object, determining that the at least one detected external object is one of the plurality of construction structure candidates, and wherein the at least one detected external object is classified as an unclassified object.

16. The method of claim 15, wherein the determining of the plurality of construction structure candidates comprises determining that the unclassified object is one of the plurality of construction structure candidates based on:
a size of the unclassified object being less than or equal to a reference size,
a speed of the unclassified object being less than or equal to a reference speed, and
the unclassified object occupying a road.

17. A vehicle comprising:
a sensor configured to obtain object information of at least one external object in a surrounding environment of the vehicle;
a driving control circuit configured to control autonomous driving of the vehicle; and
a processor circuit configured to cause the vehicle to:
determine, based on the object information, a class of the at least one external object,
identify, based on the class and the object information, a plurality of candidate structures,
determine, based on clustering the plurality of candidate structures, at least one construction structure,
identify, based on the at least one construction structure, an avoidance zone,
select, based on the avoidance zone, a driving operation of the vehicle,
output, based on the driving operation, a signal indicating a driving route of the vehicle, and
control, via the driving control circuit and based on the signal, autonomous driving of the vehicle.

18. The vehicle of claim 17, wherein the processor circuit is configured to cause the vehicle to determine a level of similarity between a candidate structure and a reference object, based on location information of the at least one external object and lane link information associated with the driving route of the vehicle, and wherein the candidate structure is one of the plurality of candidate structures.

19. The vehicle of claim 17, wherein the processor circuit is configured to cause the vehicle to determine the driving operation as at least one of:
biased driving within a lane,
lane encroaching bias, or
a lane change.

20. The vehicle of claim 17, wherein the processor circuit is configured to cause the vehicle to identify the avoidance zone by adding a buffer zone to a construction zone, wherein the buffer zone is set based on a speed limit associated with the driving route of the vehicle, and wherein the construction zone is defined based on the construction structure.
